(19) United States
(12) Patent Application Publication
(10) Pub. No.: US 2019/0049306 A1
(43) Pub. Date: Feb. 14, 2019

(54) CALIBRATION FOR BAKING CONTRAST UNITS

(71) Applicant: WESTCO SCIENTIFIC INSTRUMENTS, INC, BROOKFIELD, CT (US)

(72) Inventors: Jerome J. Workman, JR., Marlborough, MA (US); Mikhael G. Jobran, Webster, MA (US); Robert John Winson, Upton, MA (US)

(21) Appl. No.: 15/673,958

(22) Filed: Aug. 10, 2017

(51) Int. Cl. G01J 3/52; G01J 3/46

(52) U.S. Cl. CPC G01J 3/524; G01J 3/463; G01J 3/461

(57) ABSTRACT

The calibration of an instrument, such as a spectrophotometer, for measuring baking contrast units (BCUs) is described. In one example, a spectrophotometer includes a filter wheel including, among other filters, a bandpass filter to transmit a range of broadband light through the spectrophotometer. The spectrophotometer also includes a detector to detect a reference sample value based on a reflection of the range of light off a BCU reference standard. Processing circuitry in the spectrophotometer is configured to calculate a reflectance ratio value based on a ratio of the reference sample value and a reference reflectance value, and calibrate the spectrophotometer for measuring BCUs based on the reflectance ratio value and a known BCU value for the BCU reference standard. The reference sample value and the reference reflectance value can also be corrected for measurement drift attributed to a source of the broadband light and/or the detector over time.

### BACKGROUND

The baking contrast unit (BCU) is a unit of measure of lightness or darkness. In the baking industry, for example, the color of baked goods can be quantified in BCUs for consistency in finished appearance. Analyzers that measure BCUs can be used to measure the color of various foods and ingredients of foods, such as baked crusts, baked bread crumbs, baked cookies, various types of flours or flour blends, various types of brown sugars, and other products. The unit of measure is not limited to use with baked goods or ingredients for baked goods, as it can also be used for processed, fried, smoked, and grilled foods, and it can be applied to measurements in other industries.

### BRIEF DESCRIPTION OF THE DRAWINGS

Aspects of the embodiments described herein can be better understood with reference to the following drawings. The elements in the drawings are not necessarily to scale, with emphasis instead being placed upon clearly illustrating the principles of the embodiments. Additionally, certain dimensions or positionings can be exaggerated to help visually convey certain principles. In the drawings, similar reference numerals between figures designate like or corresponding, but not necessarily the same, elements.

FIG. 1 illustrates an example instrument according to various embodiments described herein.

FIG. 2 illustrates an example process of calibration for baking contrast units according to various embodiments described herein.

FIG. 3 illustrates an example linear fit for calibration of the instrument shown in FIG. 1 according to various embodiments described herein.

FIG. 4 illustrates an example polynomial fit between for calibration of the instrument shown in FIG. 1 according to various embodiments described herein.

FIG. 5 illustrates an example schematic block diagram of a processing circuitry environment which can be employed in the instrument shown in FIG. 1 according to various embodiments described herein.

### DESCRIPTION

As discussed above, the baking contrast unit (BCU) is a unit of measure of lightness or darkness. In the baking industry, for example, the color of baked goods can be quantified in BCUs for consistency in finished appearance. Analyzers that measure BCUs can be used to measure the color of various foods and ingredients of foods, such as baked crusts, baked bread crumbs, baked cookies, various types of flours or flour blends, various types of brown sugars, and other products.

The unit of measure for the BCU is derived from the Tristimulus L value, which is based on the Y value, having a maximum at the 550 nm wavelength, of the X-Y-Z Tristimulus color measurement system. The formula used by HUNTERLAB® for BCUs, for example, is BCU=log 2 (Y/2.5) where Y=CIE Tristimulus Y brightness value for D65/10° illuminant/observer conditions. The BCU range in that case is from 0.00 (i.e., darkest) to 5.25 (i.e., lightest) BCU, and a difference of 0.1 BCU units is estimated to be a visual difference in the product.

To compute the X-Y-Z Tristimulus values from the visible spectrum of a sample, whether in reflection or transmission, the following equations can be used:

$$\begin{matrix}X = k \cdot {\int }_{380}^{780} R ( λ ) \cdot S ( λ ) \cdot {\overline{x}}_{2} ( λ ) d λ , & ( 1 ) \\ Y = k \cdot {\int }_{380}^{780} R ( λ ) \cdot S ( λ ) \cdot {\overline{y}}_{2} ( λ ) d λ , and & ( 2 ) \\ Z = k \cdot {\int }_{380}^{780} R ( λ ) \cdot S ( λ ) \cdot {\overline{z}}_{2} ( λ ) d λ , where & ( 3 ) \\ k = \frac{100}{{\int }_{380}^{780} S ( λ ) \cdot {\overline{y}}_{2} ( λ ) d λ} . & ( 4 )\end{matrix}$$

R(λ) is the reflectance or transmittance visible spectrum of the sample using the appropriate sample measurement geometry. R(λ) is in units of 0.0 to 1.0 for the reflectance or transmittance values. S(λ) is the relative spectral power distribution of the illuminant (generally either standard illuminant D65 or standard illuminant A). The color matching functions representing the human eye sensitivity to Red, Green, and Blue (RGB) are given as x̅₂, y̅₂, z̅₂ or x̅₁₀, y̅₁₀, z̅₁₀ for the 2° and 10° standard observer tables, respectively.

BCUs can be measured by various types of instruments, including but not limited to spectrophotometers and related instruments. Spectrophotometers can be used to qualitatively measure the reflection or transmission properties of materials as a function of wavelength. Spectrophotometers can operate over one or more of the visible, near-ultraviolet, and near-infrared wavelength ranges of the electromagnetic spectrum. Spectrophotometer are often used for the measurement of the transmittance or reflectance of solutions and transparent and opaque solids. Spectrophotometers generally rely upon calibration using standards that vary in form and/or type depending on the wavelength of the photometric determination.

According to aspects of the embodiments described herein, a spectrophotometer, BCU analyzer, or other instrument incorporates a bandpass filter with a center wavelength near 550 nm, having a linewidth of between 5 nm and 100 nm, preferably between 5 nm to 50 nm. In the instrument, broadband light is passed through the filter, and a resulting (e.g., filtered) range of the broadband light is directed through the instrument for taking reflectance samples.

Using the range of the broadband light, one or more reference reflectance values are measured by the instrument based on a reflection of the range of light off of one or more reflectance standards (e.g., 0.95 to 1 reflectance standards). Further, one or more BCU reference sample values are measured by the instrument based on a reflection of the range of light off one or more BCU reference standards. Additionally, the range of light is used to measure one or more reference correction values. As described in further detail below, the reference correction values can be used to correct for measurement drift attributed, for example, to electrical variations in the source of the broadband light and/or the detector of the instrument which occur over time (e.g., due to temperature variations, electrical drift, etc.).

The instrument detects and stores the reference reflection values, the BCU reference sample values, and the reference correction values over time. One or more of the reference reflectance values and the BCU reference sample values can be corrected for drift and used to determine one or more reflectance ratios, R, as shown in Equations (5)-(7) below. In Equations (5)-(7), S_{REFL} is a reference reflection value, S_{BCU} is a BCU reference sample value, REF is a reference correction value, and (i) is a dark current correction value.

$$\begin{matrix}R = \frac{( I )}{( {I}_{0} )} , where & ( 5 ) \\ I = \frac{( {S}_{BCU} - i )}{( REF - i )} and & ( 6 ) \\ {I}_{O} = \frac{( {S}_{REFL} - i )}{( REF - i )} . & ( 7 )\end{matrix}$$

Each of the resulting reflection ratios, R, can be converted to a Y value from the X-Y-Z Tristimulus calculations for D65/10°, typically. The Y value for each sample can then be converted to BCUs using Equation (8) below.

$$BCU = {log}_{2} ( \frac{Y}{2.5} ) . \qquad ( 8 )$$

Since the typical BCU requires the complete Y vector (as in Equation 2), the single Y value can be converted to a BCU by referring the reflection (as in Equation 5) directly to BCU units for a set of BCU reference sample values to calibrate the instrument.

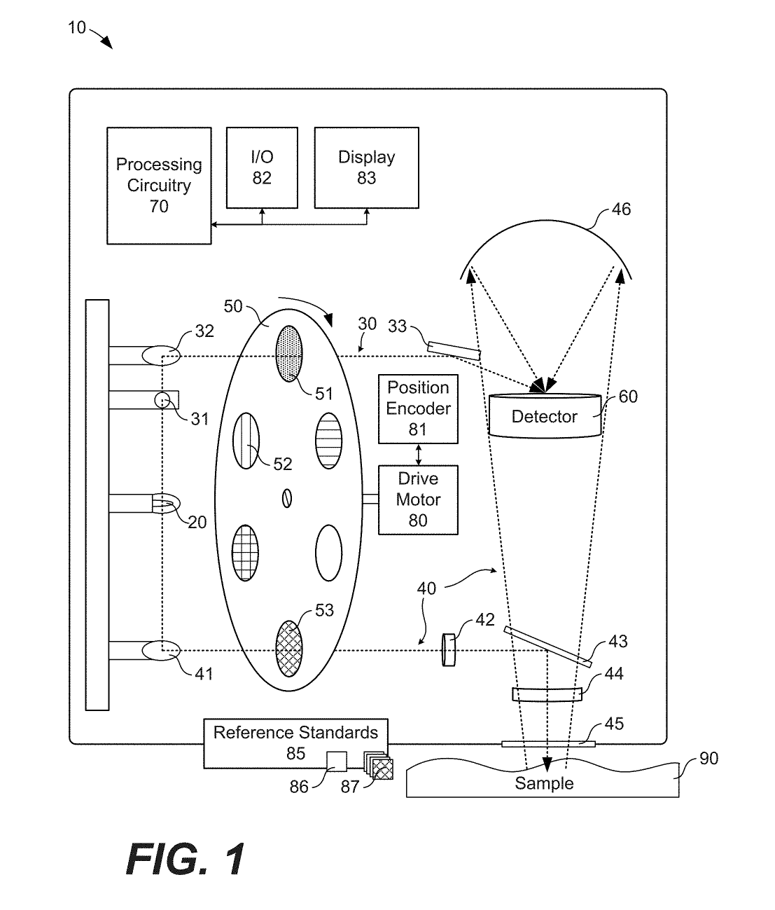

Turning to the figures, an instrument and its components are described, followed by a discussion of the operation of the same. FIG. 1 illustrates an example instrument 10. The instrument 10 can be a spectrophotometer, for example, or another related instrument. FIG. 1 is presented as a representative example of the types of parts or components that can be relied upon in the instrument 10, but it is not exhaustive. The relative sizes and placements of the components is representative and not drawn to scale in FIG. 1. It is also noted that other instruments, other components, and other arrangements of components can be relied upon for the concepts of BCU calibration described herein.

As shown in FIG. 1, the instrument 10 includes a light source 20, a reference pathway 30 (“pathway 30”), a reflection pathway 40 (“pathway 40”), a filter wheel 50, a detector 60, processing circuitry 70, a drive motor 80 for the filter wheel 50, a position encoder 81 for the drive motor 80, an input/output (I/O) interface 82, a display 83, and a number of reference standards 85. Among others, a primary feature of the instrument 10 can be the ability to measure the BCU associated with a sample, such as the sample 90 shown in FIG. 1. In a production or manufacturing setting, items such as baked goods or other products can be fed under the instrument 10, and the instrument 10 can measure various characteristics of the products, such as the BCUs (e.g., darkness or lightness) associated with the products over time.

The reference pathway 30 is an optical pathway through which light from the light source 20 passes through the instrument 10 without reflecting off the sample 90 or the reference standards 85 before being detected and measured by the detector 60. The sample reflection pathway 40, on the other hand, is an optical pathway through which light from the light source 20 passes through the instrument 10, exits the instrument 10 to illuminate the sample 90, and reflects back into the instrument 10 for detection and measurement by the detector 60. During BCU calibration, however, one or more of the reference standards 85 can be inserted into the pathway 40 so that the detector 60 will detect the reflection of light off of the references standards 85.

The light source 20 can include a source of broadband light, such as a halogen light bulb, although any source of broadband light suitable for the application can be relied upon. Thus, the light source 20 can emit a wide range of wavelengths of light.

In the reference pathway 30, light from the light source 20 passes through a focusing lens 31, is reflected off a mirror 32, passes through a filter of the filter wheel 50 (or is blocked by the filter wheel 50), reflects off a mirror 33, and is directed to fall incident on the detector 60. In the sample reflection pathway 40, light from the light source 20 is reflected off a mirror 41, passes through a filter of the filter wheel 50 (or is blocked by the filter wheel 50), passes through a lens 42, reflects off a mirror 43, passes through a lens 44, passes through an exit opening 45 of the instrument 10, and is directed to fall incident on the sample 90. Light reflected off the sample 90 passes back through the exit opening 45, reflects off a mirror 46, and is directed to fall incident on the detector 60. The reference pathway 30 and the sample reflection pathway 40 are provided as representative examples in FIG. 1. In other cases, other arrangements of mirrors, lenses, filters, and other optical elements can be relied upon, and the pathways can be of any suitable length, shape, and dimensions.

The filter wheel 50 includes a number of filters 51-53, among others. In various embodiments, the filter wheel 50 can include any suitable number of different filters. The filter wheel 50 can be rotated by a drive motor 80 about a pivot point so that one or more of the filters 51-53 intersect, individually, with reference pathway 30 and the sample reflection pathway 40. Although the filter 51 is shown to intersect with the reference pathway 30 and the filter 53 is shown to intersect with the sample reflection pathway 40 at the same time in FIG. 1, the filter wheel 50 can be constructed so that only one of the filters 51-53 intersects with one of the pathways 30 or 40 at a time. Thus, light from the light source 20 reaches the detector 60 through only one of the pathways 30 or 40 at a time, and light is blocked from passing through the other one of the pathways 30 or 40 by the filter wheel 50.

According to aspects of the embodiments, the filter 51 can be embodied as a dielectric bandpass filter with a center wavelength near 550 nm (e.g., a Y or green filter), having a linewidth of between 5 nm and 100 nm, preferably between 5 nm to 50 nm. Thus, the filter 51 is designed or constructed to transmit a relatively more narrow range of the broadband light emitted by the light source 20. Among other manufacturers, the filter 51 can be manufactured by THORLABS® of Newton, N.J. As described herein, the filter 51 is selected for a center wavelength (i.e., near 550 nm) corresponding to the Tristimulus Y brightness value for the purpose of taking measurements for BCU calibration. The other filters 52, 53, etc., in the filter wheel 50 can be selected to pass and/or stop other ranges of the broadband light emitted from the light source 20. The other filters 52, 53, etc. can be relied upon by the instrument 10 for taking other near-infrared (NIR) measurements (e.g., besides BCU calibration) for quantitative analysis.

The detector 60 is configured to detect and measure (e.g., quantify) the intensity of light, over a range of wavelengths, that falls incident upon it. During measurements, the detector 60 and/or the processing circuitry 70 converts the light to electrical signals and data values from which a quantitative analysis of various characteristics of the sample 90 can be performed. The analysis can include a constituent analysis for moisture content, fat content, protein content, taste, texture, viscosity, and other factors.

The detector 60 can be embodied as one or more charge-coupled device (CCD) sensors, complementary metal oxide semiconductor (CMOS) sensors, or related type(s) of light or electromagnetic sensors. As examples, a combined detector having both silicon (Si) and lead sulfide (PbS), silicon and indium gallium arsenide (InGaAs), a wafer detector (e.g., 2-color detector) combining silicon and lead sulfide (Si—PbS), or a wafer detector combining silicon and indium gallium arsenide (Si—InGaAs) detectors can be used.

For the purpose of BCU calibration, the detector 60 is configured to detect and measure light that passes through both the pathways 30 and 40 over time. Based on those measurements, the detector 60 collects, and the processing circuitry 70 stores and processes, a number of different types of sample values, including one or more reference correction values, BCU reference sample values, and reference reflectance values. The reference correction values are detected and measured based on the light from the light source 20 that passes though the pathway 30. The BCU reference sample values are detected and measured based on the light from the light source 20 that passes though the pathway 40, reflects off of one of the BCU reference standards 87, and is reflected back into the instrument 10. Finally, the reference reflectance values are detected and measured based on the light from the light source 20 that passes though the pathway 40, reflects off of the reflectance standard 86, and is reflected back into the instrument 10.

Thus, as described in further detail below, the detector 60 is configured to detect and measure the reference correction values based on the range of the broadband light from the light source 20 that passes through the filter 51 in the pathway 30. The detector 60 is further configured to detect and measure the BCU reference sample values based on reflections of the range of light off of the BCU reference standards 87, as those reflections are carried back into the instrument 10 through the sample reflection pathway 40. The detector 60 is additionally configured to detect and measure the reference reflectance values based on reflections of the range of light off of the reflectance standard 86.

The reference standards 85 include at least one reflectance standard 86 and one or more BCU reference standards 87. The reference standards 85 are used to take reflectance measurements by the instrument 10 for BCU calibration as described in further detail below. The reflectance standard 86 can be embodied as a 0.95 or 1.0 reflectance standard, for example, formed from any suitable material(s), although standards exhibiting other levels of reflectance can be used. The BCU reference standards 87 can be embodied as a suitable number of reference standards each having a BCU value that is known and stored in memory by the processing circuitry 70. An example using four BCU reference standards 87 is described below, but any number of BCU reference standards 87 can be relied upon. For robust calibration, the BCU reference standards 87 can selected to have a range of different BCU values between 0.00 (i.e., darkest) to 5.25 (i.e., lightest), for example.

In one example case, the reflectance standard 86 and the BCU reference standards 87 can be secured to paddles, a standards wheel, etc., and inserted, individually, into the sample reflection pathway 40 by a mechanical means controlled by the processing circuitry 70. In other cases, the reflectance standard 86 and the BCU reference standards 87 can be inserted into the sample reflection pathway 40 by a user based on prompts provided on the display 83 of the instrument 10.

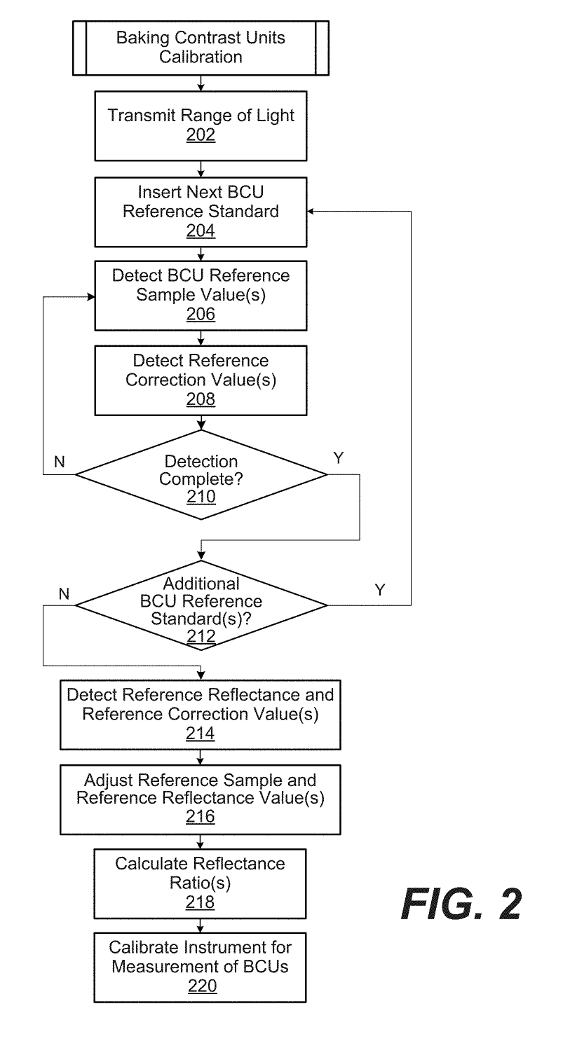

The processing circuitry 70 can be embodied as one or more circuits, processors, processing circuits, or any combination thereof that monitors and controls the operations of the instrument 10. The processing circuitry 70 can be configured to coordinate the components of the instrument 10 and perform calculations to implement the process of BCU calibration described below with reference to FIG. 2. In that context, the processing circuitry 70 can be configured to capture, store in memory, and analyze signals, samples, and data values provided to it by the detector 60, the position encoder 81, and other components. The processing circuitry 70 can also be configured to communicate data over the I/O interface 82 and display information on the display 83.

To facilitate the collection of the reference correction values, the BCU reference sample values, and the reference reflectance values using the detector 60, the processing circuitry 70 can control the position, rate of angular velocity, and/or acceleration of the filter wheel 50 by way of the drive motor 80. The drive motor 80 can be embodied as any suitable permanent magnet motor, such as a stepper motor that directly drives the rotation of the filter wheel 50, although other types of motors can be used. For example, variable reluctance motors, brushless DC motors, hybrid stepper motors, or servo motors can be relied upon. Preferably, the drive motor 80 is selected to provide a continuous or nearly continuous range of angular displacement with good response to control by the processing circuitry 70.

The position encoder 81 provides feedback to the processing circuitry 70 as to the angular orientation of the filter wheel 50. For example, the position encoder 81 can provide an encoded signal representative of the absolute (or possibly relative) angular orientation or position of the filter wheel 50 and, thus, the filters 51-53 of the filter wheel 50. This position information is provided to the processing circuitry 70 as feedback to time and synchronize measurements taken by the detector 60. The position encoder 81 can be selected from among any suitable rotary position encoder having high enough resolution in rotary position for the application.

Turning to more details on the manner of BCU calibration performed by the instrument, FIG. 2 illustrates an example process of BCU calibration according to various embodiments described herein. The flowchart shown in FIG. 2 can be viewed as a representative set of steps performed by the instrument 10 shown in FIG. 1, although other related instruments can perform the process. Although a particular order of steps is shown in FIG. 2, the process can proceed according to other orders or of steps or operations. Further, certain steps can be performed concurrently with other steps, with partial concurrence, repeatedly, or at different times as compared to that shown.

At step 202, the process includes the light source 20 transmitting a range of broadband light. For example, the processing circuitry 70 can control a supply of power to the light source 20, and the light source 20 will emit broadband light in response to the supply of power. Depending upon the position of the filter wheel 50, which can rotate over time, the broadband light can be filtered by the filter 51 and travel along one of the pathways 30 and 40. At step 202, the process also includes the processing circuitry 70 monitoring the position of the filter wheel 50 and the filter 51 over time based on feedback from the position encoder 81. The processing circuitry 70 can then control the detector 60 to detect light and take measurements at the appropriate timings in the process, particularly at steps 204, 206, 208, and 210 as described below.

At step 204, the process includes the processing circuitry 70 inserting one of the BCU reference standards 87 into the sample reflection pathway 40 for measurement. As discussed above, the BCU reference standards 87 can include a number of reference standards each having a known BCU value. In one example case, the BCU reference standards 87 (and the reflectance standard 86) can be secured to paddles, a standards wheel, etc. In that case, at step 204, the processing circuitry 70 can mechanically control the paddles, standards wheel, etc., to insert one of the BCU reference standards 87 into the sample reflection pathway 40. In another case, one of the BCU reference standards 87 can be manually inserted into the reflection pathway 40 at step 204 by a user of the instrument 10 based on a prompt provided on the display 83, for example.

Step 204 occurs as part of a cycle along with steps 206, 208, and 210, as shown in FIG. 2. As described further below, step 206 includes detecting a BCU reference sample value associated with the BCU reference standard 87 that was inserted into the sample reflection pathway 40 at step 202. Step 208 includes detecting a reference correction value associated with the BCU reference sample being detected at step 206. As described in further detail below, the processing circuitry 70 can calculate a response (e.g., “I” in Equation (6)) for each BCU reference standard 87 that is inserted into the sample reflection pathway 40 based on the BCU reference sample value (e.g., S_{BCU} in Equation (6)) detected at step 206 and the reference correction value (e.g., REF in Equation (6)) detected at step 208.

The filter wheel 50 is rotated by the drive motor 80 during the cycle of steps 206, 208, and 210, and the processing circuitry 70 times or coordinates the collection of sample values using the detector 60 at steps 206 and 208 to coincide with when the range of broadband light from the light source 20 is passing through either the pathway 30 or the pathway 40. In practice, steps 206 and 208 may be performed concurrently (or in an alternating sequence) as the filter wheel 50 rotates the filter 51 to intersect between the pathway 30 and the pathway 40.

At step 206, the process includes the detector 60 detecting a BCU reference sample value corresponding to the BCU reference standard 87 that was inserted into the sample reflection pathway 40 at step 204. More particularly, a BCU reference sample value is detected by the detector 60 at step 206 as the range of light from the light source 20 passes though the filter 51 in the pathway 40, reflects off of the BCU reference standard 87 inserted at step 204, and is reflected back into the instrument 10 to fall incident on the detector 60 (and this can occur intermittently over time as the filter wheel 50 spins).

At step 208, the process includes the detector 60 detecting a reference correction value. The reference correction value can be measured by the detector 60 as the range of light from the light source 20 passes through the filter 51 in the pathway 30 and falls incident upon the detector 60 (and this can occur intermittently over time as the filter wheel 50 spins). The reference correction value can be used by the processing circuitry 70 to correct for measurement drift attributed, for example, to electrical variations in the light source 20 and/or the detector 60 which occur over time (e.g., due to temperature variations, electrical drift, etc.). This correction for drift is described in further detail below.

At step 210, the process includes the processing circuitry 70 determining whether the detecting at steps 206 and 208 is complete. In that context, it is noted that the detecting at steps 206 and 208 can continue while the filter wheel 50 rotates the filter 51 between the pathways 30 and 40. During that time, the processing circuitry 70 can average or integrate the signals captured by the detector 60 for the BCU reference sample value (e.g., step 206) and for the reference correction value (e.g., step 208). The detecting at steps 206 and 208 can continue for a certain period of time, to a suitable signal-to-noise ratio for the values, or until another predetermined measurement metric occurs.

If the detecting at steps 206 and 208 is not yet complete, then the process can proceed from step 210 back to steps 206 and 208 for further detecting. Otherwise, if the detecting is complete, then the process can proceed from step 210 to step 212.

At step 212, the process includes determining whether there is another BCU reference standard 87 to measure. An example BCU calibration based on the measurement of four BCU reference standards 87 is described herein, but any number of BCU reference standards 87 can be measured and relied upon as standards for calibration. For robust calibration, the BCU reference standards 87 can selected to have a range of different BCU values between 0.00 (i.e., darkest) to 5.25 (i.e., lightest).

If there are more BCU reference standards 87 to measure, then the process proceeds back to step 204 for the insertion of the next BCU reference standard 87. Otherwise, if all the BCU reference standards 87 have been measured, then the process proceeds to step 214.

At step 214, the process includes detecting a reference reflectance value and an associated reference correction value. To do so, the processing circuitry 70 can insert the reflectance standard 86 into the sample reflection pathway 40 for measurement. As discussed above, the reflectance standard 86 can be embodied as a 0.95 or 1.0 reflectance standard, for example, formed from any suitable material(s), although standards exhibiting other levels of reflectance can be used. The reflectance standard 86 can be secured to a paddle, a standards wheel, etc., and the processing circuitry 70 can mechanically control the paddle, standards wheel, etc., to insert the reflectance standard 86 into the sample reflection pathway 40.

The process at step 214 can also include the detector 60 detecting a reference reflectance value associated with the reflectance standard 86 and detecting a reference correction value associated with the reference reflectance value. More particularly, step 214 can include the detector 60 detecting the reference reflectance value as the range of light from the light source 20 passes though the filter 51 in the pathway 40, reflects off of the reflectance standard 86, and is reflected back into the instrument 10 to fall incident on the detector 60 (and this can occur intermittently over time as the filter wheel 50 spins). Further, step 214 can include the detector 60 detecting a reference correction value as the range of light from the light source 20 passes through the filter 51 in the pathway 30 and falls incident upon the detector 60 (and this can occur intermittently over time as the filter wheel 50 spins).

As described in further detail below, the processing circuitry 70 can calculate a response (e.g., “Io” in Equation (7)) based on the reference reflectance value (e.g., S_{REFL} in Equation (7)) and the reference correction value (e.g., REF in Equation (7)) detected at step 214. In practice, the reference reflectance value and the reference correction value can be detected simultaneously (or with partial concurrence) as the filter wheel 50 rotates the filter 51 to intersect between the pathway 30 and the pathway 40.

In some cases, it might not be necessary for the instrument 10 to collect the reference reflectance value for BCU calibration at step 214. For example, if the instrument 10 had previously collected a reference reflectance value within a predetermined period of time (e.g., within the last 30 minutes) before the BCU calibration process is started, it might not be necessary to collect it again. In that case, step 214 can be skipped or omitted from the process flow.

At step 216, the process includes the processing circuitry 70 adjusting the BCU reference sample values detected at step 206 based on the reference correction values detected at step 208. The process can also include the processing circuitry 70 adjusting the reference reflectance value detected at step 214 based on the reference correction value detected at step 214.

As one example, at step 216, each of the BCU reference sample values (e.g., S_{BCU} in Equation (6)) detected at step 206 can be adjusted based on the corresponding reference correction value detected at step 208 (e.g., REF in Equation (6)) as shown above in Equation (6), to result in a corrected response “I” for each of the BCU reference standards 87. Each corrected response “I” can also account for the dark current correction value (i), as shown in Equation (6), which is related to the signal level output by the detector 60 during dark measurements (e.g., electrical noise during dark measurements).

Further, at step 216, the reference reflectance value (e.g., S_{REFL} in Equation (7)) detected at step 214 can also be adjusted based on the corresponding reference correction value that was detected at step 214 (e.g., REF in Equation (7)) as shown above in Equation (7), to result in a corrected response “Io” for the reflectance standard 86. The corrected response “Io” can also account for the dark current correction value (i), as shown in Equation (7), which is related to the signal level output by the detector 60 during dark measurements.

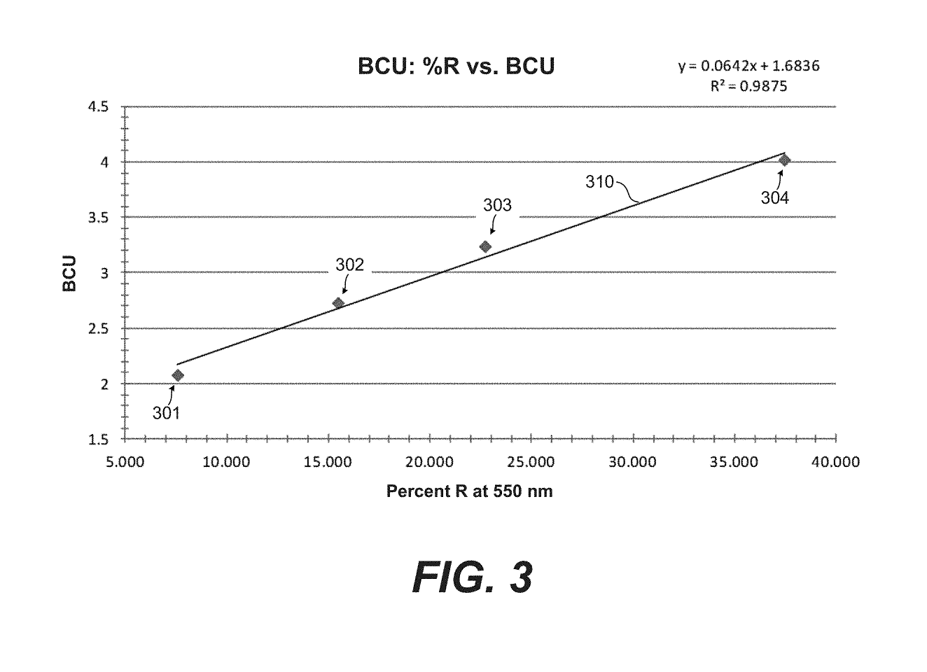

At step 218, the process includes the processing circuitry 70 calculating a reflectance ratio “R” for each of the BCU reference sample values detected at step 206. As shown in Equation 5 above, each “R” is a ratio of a corrected response “I” for one of the BCU reference sample values detected at step 206 and a corrected response “Io” for the reference reflectance value detected at step 214. Example “R” values, as percentages, are given below in Table 1, and FIG. 3 illustrates a plot of the “R” values. Table 1 shows the BCU standard number, percent reflection at 550 nm, the Tristimulus Y value, and the known BCU for the standard number for each of the BCU reference standards 87.

TABLE 1

| BCU | % R | | REF |
|---|---|---|---|
| STND | 550 nm | Y | BCU |
| 1 | 15.463 | 16.60 | 2.73 |
| 2 | 7.570 | 10.56 | 2.08 |
| 3 | 37.430 | 40.65 | 4.02 |
| 4 | 22.700 | 23.69 | 3.24 |

At step 220, the process includes the processing circuitry 70 calibrating the instrument 10 for measuring BCUs based on the reflectance ratio values calculated at step 218 and the known BCU values for the BCU reference standards 87. For example, each of the “% R” (i.e., the result of Equation (5) multiplied by 100) or “R” values calculated in step 218 can be correlated to the known BCU value of the BCU reference standard 87 used to obtain it, using a linear or non-linear regression method, such as linear regression or polynomial regression. The embodiments are not limited to the use of linear regression or polynomial regression, however, as any suitable fitting function for optimizing the relationship between measured and actual BCU values can be used.

To illustrate step 220, FIG. 3 shows an example linear fit for calibration of the instrument 10 shown in FIG. 1. As shown in FIG. 3, each of the data points 301-304 can be plotted, along the horizontal axis, based on one of the “% R” values from Table 1. Along the vertical axis, each of the data points 301-304 can be plotted according to the known BCU value of the BCU reference standard 87 used to obtain it.

Using the data points 301-304, the processing circuitry 70 can model the relationship between all “% R” values and corresponding BCU values using simple linear regression at step 220. In that context, an example linear model 310 is shown in FIG. 3, and it is defined according to the expression in the upper right hand corner in FIG. 3. Once the linear model 310 is developed through calibration at step 220, an accompanying BCU value can be identified as a measured BCU value by the instrument 10 for any new “% R” or “R” value.

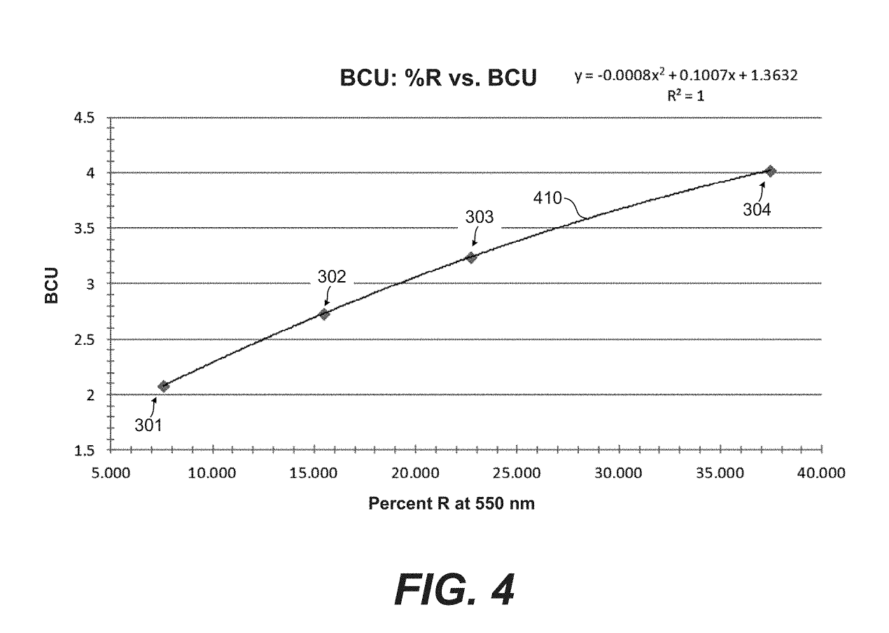

The calibration at step 220 is not limited to generating models based on simple linear regression, however, and FIG. 4 illustrates the use of an example polynomial fit. Again, each of the data points 301-304 is plotted, along the horizontal axis, based on one of the “% R” values from Table 1. Along the vertical axis, each of the data points 301-304 is plotted according to the known BCU value of the BCU reference standard 87 used to obtain it.

The processing circuitry 70 can model the relationship between all “% R” values and corresponding BCU values based on the data points 301-304 using polynomial regression at step 220. In that context, an example polynomial model 410 is shown in FIG. 4, and it is defined according to the expression in the upper right hand corner in FIG. 4. Once the polynomial model 410 is developed through calibration at step 220, an accompanying BCU value can be identified as a measured BCU value by the instrument 10 for any new “% R” or “R” value.

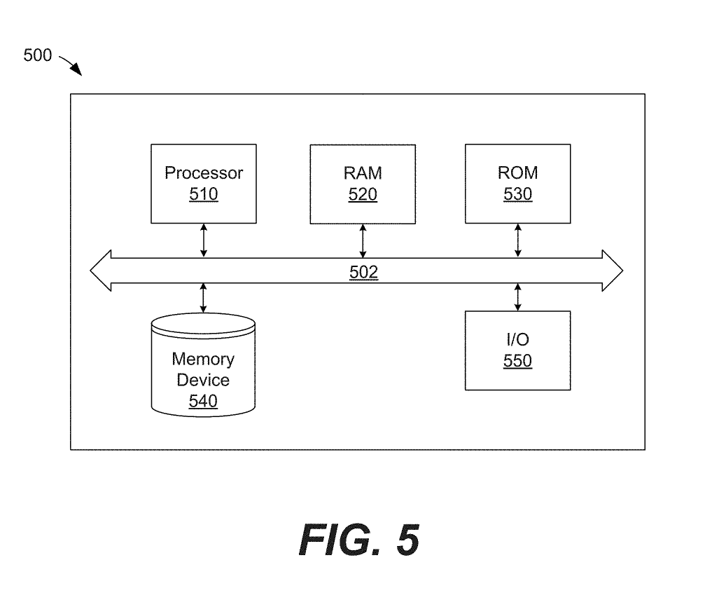

FIG. 5 illustrates an example schematic block diagram of a processing device including processing circuitry 500 which can be employed for the processing circuitry 70 in the instrument 10 shown in FIG. 1 according to an embodiment described herein. The processing circuitry 500 can be embodied, in part, using one or more elements of a special purpose or embedded computer. The processing circuitry 500 includes a processor 510, a random access memory (RAM) 520, a read only memory (ROM) 530, a memory device 540, and an Input Output (“I/O”) interface 550. The elements of the processing circuitry 500 are communicatively coupled via a local interface 502. The elements of the processing circuitry 500 described herein are not intended to be limiting in nature, and the processing circuitry 500 can include other elements.

In various embodiments, the processor 510 can comprise any well-known general purpose arithmetic processor, programmable logic device, state machine, or application specific integrated circuit (ASIC), for example. The processor 510 can include one or more circuits, one or more microprocessors, ASICs, dedicated hardware, or any combination thereof. In certain aspects embodiments, the processor 510 is configured to execute one or more software modules. The processor 510 can further include memory configured to store instructions and/or code to various functions, as further described herein. In certain embodiments, the processor 510 can comprise a general purpose, state machine, or ASIC processor, and the process described in FIG. 2 can be implemented or executed by the general purpose, state machine, or ASIC processor according software execution, by firmware, or a combination of a software execution and firmware.

The RAM and ROM 520 and 530 can comprise any well-known random access and read only memory devices that store computer-readable instructions to be executed by the processor 510. The memory device 540 stores computer-readable instructions thereon that, when executed by the processor 510, direct the processor 510 to execute various aspects of the embodiments described herein.

As a non-limiting example group, the memory device 540 can comprise one or more non-transitory devices or mediums including an optical disc, a magnetic disc, a semiconductor memory (i.e., a semiconductor, floating gate, or similar flash based memory), a magnetic tape memory, a removable memory, combinations thereof, or any other known memory means for storing computer-readable instructions. The I/O interface 550 cam comprise device input and output interfaces such as keyboard, pointing device, display, communication, and/or other interfaces, such as a network interface, for example. The local interface 502 electrically and communicatively couples the processor 510, the RAM 520, the ROM 530, the memory device 540, and the I/O interface 550, so that data and instructions can be communicated among them.

In certain aspects, the processor 510 is configured to retrieve computer-readable instructions and data stored on the memory device 540, the RAM 520, the ROM 530, and/or other storage means, and copy the computer-readable instructions to the RAM 520 or the ROM 530 for execution, for example. The processor 510 is further configured to execute the computer-readable instructions to implement various aspects and features of the embodiments described herein. For example, the processor 510 can be adapted or configured to execute the process described above with reference to FIG. 2.

The flowchart or process shown in FIG. 2 is representative of certain processes, functionality, and operations of embodiments discussed herein. Each block can represent one or a combination of steps or executions in a process. Alternatively or additionally, each block can represent a module, segment, or portion of code that comprises program instructions to implement the specified logical function(s). The program instructions can be embodied in the form of source code that comprises human-readable statements written in a programming language or machine code that comprises numerical instructions recognizable by a suitable execution system such as the processor 510. The machine code can be converted from the source code, etc. Further, each block can represent, or be connected with, a circuit or a number of interconnected circuits to implement a certain logical function or process step.

Although embodiments have been described herein in detail, the descriptions are by way of example. The features of the embodiments described herein are representative and, in alternative embodiments, certain features and elements can be added or omitted. Additionally, modifications to aspects of the embodiments described herein can be made by those skilled in the art without departing from the spirit and scope of the present invention defined in the following claims, the scope of which are to be accorded the broadest interpretation so as to encompass modifications and equivalent structures.

At least the following is claimed:

1. A spectrophotometer for measuring baking contrast units (BCUs), comprising:
a filter wheel comprising a bandpass filter constructed to transmit a range of broadband light in the spectrophotometer, the filter wheel being configured to pass the range of the broadband light through a sample reflection pathway in the spectrophotometer;
a detector configured to detect a reference sample value based on a reflection through the sample reflection pathway of the range of the broadband light off a BCU reference standard; and
processing circuitry configured to:
calculate a reflectance ratio value based on a ratio of the reference sample value and a reference reflectance value; and
calibrate the spectrophotometer for measuring BCUs based on the reflectance ratio value and a known BCU value for the BCU reference standard.

2. The spectrophotometer of claim 1, wherein the detector is further configured to detect the reference reflectance value based on a reflection through the sample reflection pathway of the range of the broadband light off a reflectance standard.

3. The spectrophotometer of claim 1, wherein the filter wheel is configured to alternately pass the range of the broadband light through the sample reflection pathway in the spectrophotometer or through a reference pathway in the spectrophotometer.

4. The spectrophotometer of claim 3, wherein the detector is further configured to detect a reference correction value based on the range of the broadband light through the reference pathway.

5. The spectrophotometer of claim 4, wherein, before the reflectance ratio value is calculated, the processing circuitry is further configured to adjust the reference sample value and the reference reflectance value based on the reference correction value.

6. The spectrophotometer of claim 5, wherein the reference sample value and the reference reflectance value are adjusted based on the reference correction value to correct for measurement drift attributed to at least one of a light source of the broadband light or the detector over time.

7. The spectrophotometer of claim 1, wherein the detector is further configured to detect a plurality of reference sample values corresponding respectively to a plurality of BCU reference standards, each of the plurality of reference sample values being based on a reflection through the sample reflection pathway of the range of the broadband light off a respective one of the plurality of BCU reference standards.

8. The spectrophotometer of claim 7, wherein the processing circuitry is further configured to:
calculate a plurality of reflectance ratio values, each of the plurality of reflectance ratio values being based on a ratio of a respective one of the plurality of reference sample values and the reference reflectance value; and
determine a calibrated BCU function for measuring BCUs using the spectrophotometer based on a fit between the plurality of reflectance ratio values and known BCU values for the plurality of BCU reference standards.

9. A method of calibrating a spectrophotometer for measuring baking contrast units (BCUs), comprising:
transmitting a range of broadband light through a sample reflection pathway in the spectrophotometer;
detecting, with a detector, a reference sample value based on a reflection through the sample reflection pathway of the range of the broadband light off a BCU reference standard;
calculating, with processing circuitry, a reflectance ratio value based on a ratio of the reference sample value and a reference reflectance value; and
calibrating, with the processing circuitry, the spectrophotometer for measuring BCUs based on the reflectance ratio value and a known BCU value for the BCU reference standard.

10. The method of claim 9, further comprising detecting, with the detector, the reference reflectance value based on a reflection through the sample reflection pathway of the range of the broadband light off a reflectance standard.

11. The method of claim 9, further comprising detecting, with the detector, the reference reflectance value based on a reflection through the sample reflection pathway of the range of the broadband light off a reflectance standard.

12. The method of claim 9, further comprising transmitting the range of broadband light through a reference pathway in the spectrophotometer.

13. The method of claim 12, further comprising detecting, by the detector, a reference correction value based on the range of the broadband light through the reference pathway.

14. The method of claim 13, further comprising, before calculating the reflectance ratio value, adjusting, with the processing circuitry, the reference sample value and the reference reflectance value based on the reference correction value to correct for measurement drift attributed to at least one of a light source of the broadband light or the detector over time.

16. The method of claim 9, further comprising detecting, with the detector, a plurality of reference sample values corresponding respectively to a plurality of BCU reference standards, each of the plurality of reference sample values being based on a reflection through the sample reflection pathway of the range of the broadband light off a respective one of the plurality of BCU reference standards.

17. The method of claim 16, further comprising:
calculating, with the processing circuitry, a plurality of reflectance ratio values, each of the plurality of reflectance ratio values being based on a ratio of a respective one of the plurality of reference sample values and the reference reflectance value; and
determining, with the processing circuitry, a calibrated BCU function for measuring BCUs using the spectrophotometer based on a fit between the plurality of reflectance ratio values and known BCU values for the plurality of BCU reference standards.

18. A spectrophotometer, comprising:
a detector configured to detect a reference sample value based on a reflection of a range of light off a baking contrast unit (BCU) reference standard; and
processing circuitry configured to:
calculate a reflectance ratio value based on a ratio of the reference sample value and a reference reflectance value; and
calibrate the spectrophotometer for measuring BCUs based on the reflectance ratio value and a known BCU value for the BCU reference standard.

19. The spectrophotometer of claim 18, wherein the detector is further configured to detect a reference correction value based on the range of the light.

20. The spectrophotometer of claim 19, wherein, before the reflectance ratio value is calculated, the processing circuitry is further configured to adjust the reference sample value and the reference reflectance value based on the reference correction value.
